(19) United States
(12) Patent Application Publication
(10) Pub. No.: US 2013/0208478 A1
(43) Pub. Date: Aug. 15, 2013

(54) ADAPTOR FOR CONVERTING LASER DEVICES TO LIGHTING

(71) Applicants: Robin Michael Bowden, Birkenhead (GB); Xiao Pei Tao, Shanghai (CN)

(72) Inventors: Robin Michael Bowden, Birkenhead (GB); Xiao Pei Tao, Shanghai (CN)

(73) Assignee: Xiao Pie Tao, Shanghai (CN)

(21) Appl. No.: 13/396,585

(22) Filed: Feb. 14, 2012

(51) Int. Cl. F21V 7/22

(52) U.S. Cl. 362/260

(57) ABSTRACT

A detachable device to convert a laser into a light source such as a flashlight or other illumination light source is provided. An adapter is provided whose output is coaxial to the path of the illuminating beam using rear illumination of the phosphor. A dichroic mirror is used as the substrate to which the phosphor adhered. The dichroic mirror is chosen to have low reflectivity at the illuminating wavelength (typically 445 nm) and to have high reflectivity for wavelengths longer than that of the illuminating source. The dichroic coating may either be on the same side as the phosphor or the opposite side to the phosphor.

### BACKGROUND

A laser pointer or laser pen is a small portable device with a power source (usually a battery) and a laser emitting a very narrow coherent low-powered beam of visible light, intended to be used to highlight something of interest by illuminating it with a small bright spot of colored light. Higher powered versions are intended for experimental or original equipment manufacturer (OEM) use.

Higher powered lasers are now routinely available to the general public. The recent low-cost availability of 1 W 445 nm lasers and 0.5 W 405 nm lasers has added to their popularity. 445 nm Blue and particularly 405 nm Violet lasers are of wavelengths to which the human eye is less sensitive. Lasers beams at these wavelengths may have perceived low brightness but be of hazardous power.

However usage of such aforementioned laser devices is limited to experimental or original equipment manufacturer (OEM) use as their power levels pose a safety hazard when used as laser pointers. What is needed is a means to expand their use beyond experimental or OEM use so that laser enthusiasts and others users of such devices can receive additional utility from these laser devices. Further needed within the field is a means to produce low powered illumination from fixed or portable laser beam generating devices to save power and provide multiple uses for laser devices, enabling their use in various manners, such as an all in one tool capable of starting fires, providing illumination and signaling in an emergency.

### SUMMARY OF THE INVENTION

In general, the foregoing and other objects are achieved with the invention as follows:

In one aspect, the invention is in an adaptor capable of converting one or more laser source beams into illuminating light suitable for use as a light source to aid vision.

In one aspect, the invention is in an adaptor capable of converting one or more laser source beams into colored light suitable for theatrical or other recreational use or for use as illumination.

In another aspect, the invention is in an adaptor capable of converting a portable laser into a flashlight.

In yet another aspect, the invention is in an optionally detachable device to convert a portable blue or violet laser into a white light flashlight.

In yet another aspect, the invention is in an optionally detachable device to convert a portable blue or violet laser into a colored light flashlight or light source.

### BRIEF DESCRIPTION OF THE DRAWINGS

FIG. 1 is an adaptor embodiment of the present invention.

FIG. 2 is an adaptor embodiment of the present invention.

FIG. 3 is an adaptor embodiment of the present invention.

FIG. 4 is a depiction of the effect of the dichroic coating and phosphor resin on a laser beam.

FIG. 5 is an adaptor embodiment of the present invention.

FIG. 6 is a depiction of a hot spot caused by a focused laser beam.

FIG. 7 is a depiction of a diffracted laser beam.

FIG. 8 is a depiction of an adaptor embodiment of the present invention.

FIG. 9 is a depiction of the functioning of an adaptor embodiment of the present invention.

### DETAILED DESCRIPTION OF THE INVENTION

The present invention is directed, inter alia, to conversion of lasers into lights of various colors. When modified in accordance with the embodiments of the present invention, a laser can be converted, via an adaptor, into a light capable of illumination in a variety of colors as well as white light suitable for vision in dark or darkened areas. Such converted lasers are useful as portable flashlights or regular lights (e.g. light bulbs) and their colored light versions are also useful as decorative fixed or portable lighting elements in light shows and to produce light of a range of colors.

A central feature of the invention is the creation of high efficiency lighting by converting some of the laser input into white appearing light output via a wavelength conversion material such as a phosphor fitted onto an adaptor device. This “white light” consists partially of the original source laser's light but has in addition a broad spectrum of other wavelengths from the emission of the phosphor.

Still another feature of the invention is the creation of colored light from laser input by utilising different phosphors or blends of different phosphors.

By way of overview, in a converted portable laser flashlight of the invention there is: (1) at least one laser source, (2) at least one reflector for the laser beam, (3) at least one phosphor and (4) at least one output beam focuser. Any laser source may be used in the present invention, however it is preferable to use a blue or violet laser source and most preferable to use a blue 445 nm laser when producing white light.

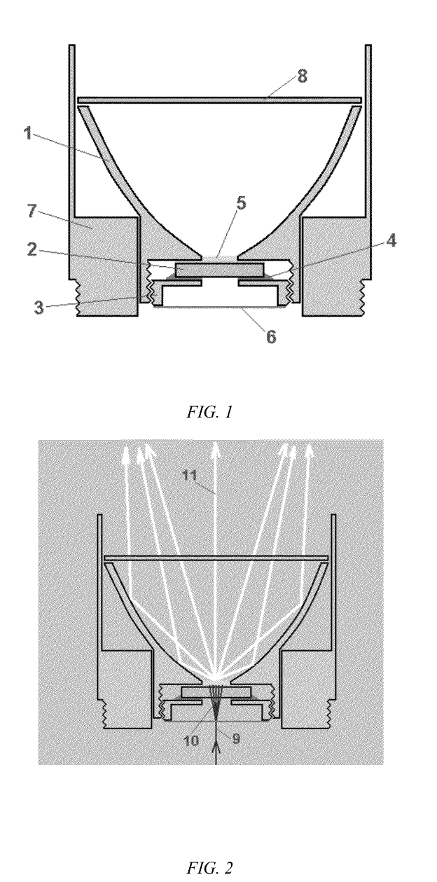

In embodiments of the invention a laser beam is reflected onto a phosphor. Suitable reflectors include a mirror, array of mirrors or a diffractive optic. While several configurations are detailed herein, reference is now made to a preferred embodiment, and to FIGS. 1 and 2. In a preferred embodiment the laser is coaxial to an adaptor for converting the laser beam to illuminating light. The adaptor is composed of an output light reflector, glass substrate with a top dichroic coating, clamp, thermally conductive adhesive, wavelength conversion material, 2-axis transmissive diffraction grating, module holder, and clear window.

In a preferred embodiment, the light conversion module (reference numbers 1 to 6 inclusive in FIG. 1) fits within an adapter housing 7 whose outer diameter thread is preferably designed to screw in to a commonly available portable laser. Dust and dirt ingress is prevented by a clear window 8.

Referring now to the output light reflector 1, it is preferably a standard aluminum or brass reflector, or a reflective coating applied to the adaptor surface which receives light. More preferably the output light reflector 1 is internally silvered.

The glass substrate 2 is coated with a dichroic coating to form a dichroic mirror. The dichroic coating serves to prevent waste of reflected light. In order to make an adapter whose output is coaxial to the path of the illuminating beam the preferred method is to use rear illumination of the phosphor. In doing so, normally over 50% of the emitted light would be wasted since it is mostly emitted from the illuminated side. To recover some of this wasted light a dichroic mirror is used as the substrate for the phosphor/resin. The dichroic mirror is preferably chosen to have low reflectivity at the illuminating wavelength (typically 445 nm) and to have high reflectivity for wavelengths longer than that of the illuminating source. The dichroic coating may either be on the same side as the phosphor or the opposite side to the phosphor. Exemplary dichroic coatings include multiple layers of Tantalum pentoxide and Silicon dioxide or multiple layers of Titanium dioxide and Silicon dioxide.

Dichroic coated glass is well known in the art and available commercially from a variety of sources. To form a typical dichroic coating, multiple ultra-thin layers of different metals (such as gold or silver); oxides of such metals as titanium, chromium, aluminium, zirconium, or magnesium; or silica are vaporised by an electron beam in a vacuum chamber. The vapor then condenses on the surface of the glass in the form of a crystal structure. A protective layer of quartz crystal is sometimes added. Other variants of such physical vapor deposition (PVD) coatings are also possible. The finished glass can have as many as 30 to 50 layers of these materials, yet the thickness of the total coating is approximately 30 to 35 millionths of an inch (about 760 to 890 nm). The coating that is created is very similar to a gemstone and, by careful control of thickness, different colors may be obtained. The total light that hits the dicro layer equals the wavelengths reflected plus the wavelengths passing through the dichro layer.

The glass substrate 2 is also formed from a thermally conductive glass such as Schott Glass BK7 available from Schott North America Inc. in Elmsford, N.Y. The glass substrate 2 is preferably chosen to have a higher thermal conductivity than the wavelength conversion material 5 adhered to it. Alternatively, undoped Yttrium Aluminum Garnet (YAG), sapphire or diamond may be used as a substrate.

The clamp 3 holds the glass substrate 2 in place, optionally with a thermally conductive adhesive 4 forming the bond between the clamp 3 and the glass substrate 2. Clamping the substrate in place with a thermally conductive clamp is the preferred way of cooling the glass substrate 2 and the materials (described herein) adhered to it. Preferably the clamp 3 is formed of a thermally conductive material such as brass or aluminum; however any thermally conductive material known to those in the art may be used. The thermally conductive adhesive 4 is preferably a thermally conductive silicone adhesive such as Chomerics CHO-THERM 1641 available from Chomerics, a Division of Parker Hannifin Corp. (www.chomerics.com). Optionally, or in addition, thermal cooling can be achieved with heat dissipaters traditionally used in electronics, such as aluminum or brass heat sinks attached to the clamp 3 or directly to the glass substrate 2.

Referring now to FIGS. 4 and 1, the wavelength conversion material 5 is a phosphor resin mix capable of bonding to the glass substrate 2. Referring now to the phosphor component of the wavelength conversion material 5 it is preferably a YAG based phosphor (Cerium-doped Yttrium Aluminum Garnet (Ce3+:YAG).) which converts the laser beam from 445 nm to a white beam with the divergence and appearance of that from a white LED bulb or flashlight. The “white light” consists partially of the original 445 nm blue light but has in addition a broad spectrum of other wavelengths (in the green to red part of the spectrum) from the emission of the phosphor. The phosphor absorbs part of the 445 nm light and scatters the rest. The absorbed part is converted into longer wavelengths of light by the Stokes conversion effect of the phosphor. The phosphor may also be a yellow oxynitride phosphor. With respect to the resin, it is a resin binder having less thermal conductivity than the glass substrate 2, thus requiring the addition of the glass substrate 2 to absorb and convey heat away from the phosphors. Preferably the resin binder is an optically transparent epoxy or silicone resin such as ACC Silicones QLE1102 or ACC Silicones Qsi1222 available from ACC Silicones Ltd. located in Bridgewater, U.K.

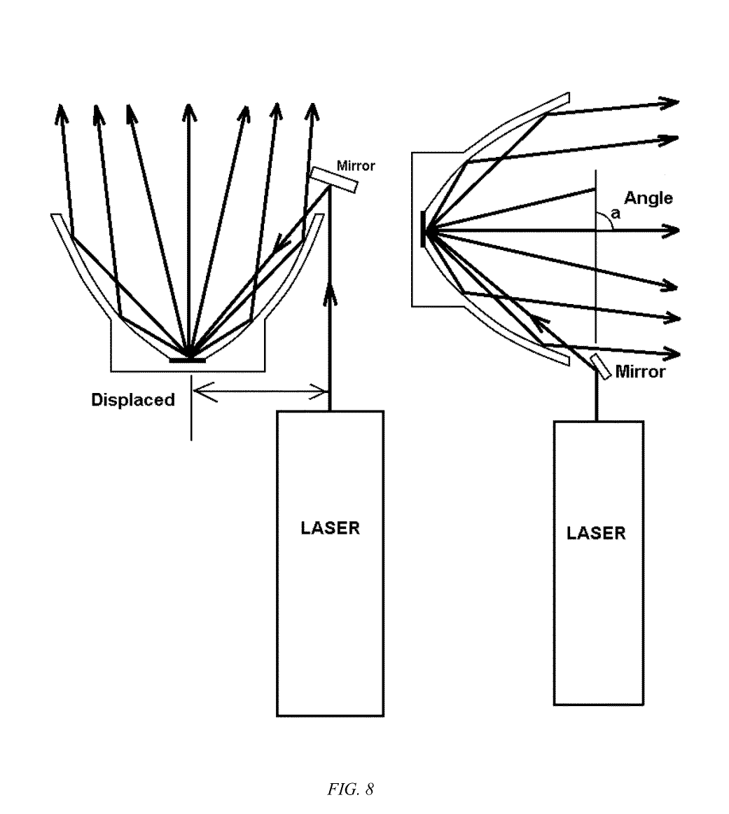

Referring again to FIG. 4, The 2 axis (X & Y) transmissive diffraction grating 6 serves to further reduce localized heating of the wavelength conversion material 5, including the resin. The near field output of commonly available 1 W 445 nm portable lasers consists of a stripe with most of the power being contained within a 2 mm×0.75 mm area. At this power density the resin containing the phosphor can easily overheat, causing discoloration or charring (a hot spot). To prevent a hot spot the active illuminated area of the phosphor may be increased by sending the illuminating beam through a 2 axis (X & Y) diffraction grating or other diverging device prior to it striking the glass substrate 2. FIG. 7 depicts an exemplary striking pattern of the laser source after passing through a 2 axis diffraction grating as compared to without a 2 axis diffraction grating (as in FIG. 6) in accordance with embodiments of the present invention. By sending the illuminating beam through the diffraction grating the illuminating laser power is spread out over a larger area of phosphor, preventing a “hot spot” forming. In FIG. 7 the grating splits the source beam in to an array of 5 by 5 output beams. Due to the oval stripe shape of the input beam the output beams overlap in the y axis. If the grating were rotated 45 degrees the spots would overlap in X and Y, however this is not strictly necessary for creating a uniform output due to the diffusing nature of the phosphor resin mix. The diverging device is preferably a concave or bi-concave lens, a transmissive diffraction grating or a transmissive holographic element.

The module holder 7, also referred to as an adaptor housing, serves to contain the components 1-6 and 8, and to allow for the mounting of a laser source, for example a portable laser, via a threaded screw as depicted in FIG. 1. It is understood that the coupling of the laser source to the adaptor housing may be done by any commonly used means including clips, slotted fittings or the like. Typically the adaptor device will be used with a 1 W 445 nm portable laser, however other wattages and wavelengths are easily substituted for use with the adaptor.

The clear plastic or glass window 8, serves to prevent dust and dirt from contacting the parts 1-6. Furthermore, the clear plastic or glass window 8 serves to prevent contact between the user and hot surfaces, and also prevent user contact or foreign object contact with the interior components 1-6 which may result in damage to the same.

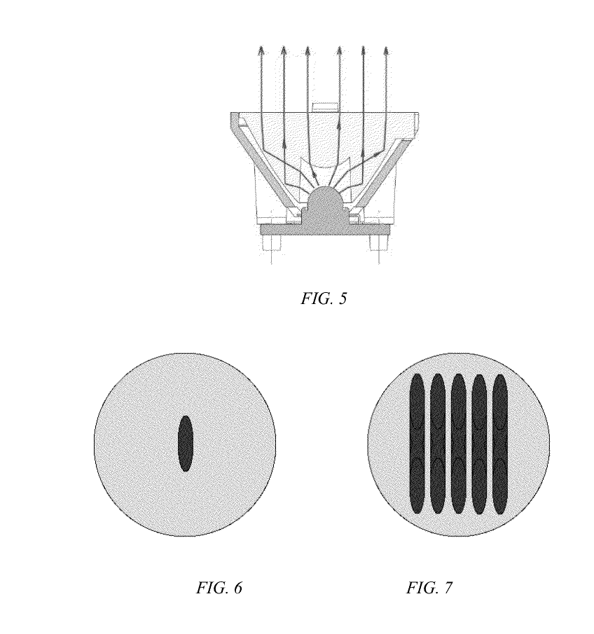

In a further embodiment, with reference to FIG. 5, since the light output from the wavelength conversion material is substantially lambertian, focusing to reduce the output beam angle provides better illumination as a flashlight . This may be done either by placing the wavelength conversion material within a curved reflector or by emitting the light into a Total Internal Reflection/Refractive optic similar to those used for collimating high power LEDs.

Now described is the operation of an embodiment of the present invention with particular reference to FIGS. 1 and 2. The collimated beam (9) from a portable laser source is caused to diverge and split into a plurality of illuminating beams (10) by a transmissive 2 axis diffraction grating (6). The diverging beams go through a glass dichroic mirror (2) before striking a patch of wavelength conversion material (5). The wavelength conversion material converts some of the illuminating light into light of longer wavelengths which combined with scattered light from the illuminating beam create a different colored output (11). Heat generated in the wavelength conversion material by the wavelength conversion process is removed from the glass substrate by the clamp (3) and thermal adhesive (4). The light output from the wavelength conversion material is substantially lambertian until it is focused into a narrower beam by the reflector (1). The outer housing (7) is externally threaded to allow attachment to a common portable laser. The clear window (8) prevents dust and dirt from contaminating the reflector and wavelength conversion material.

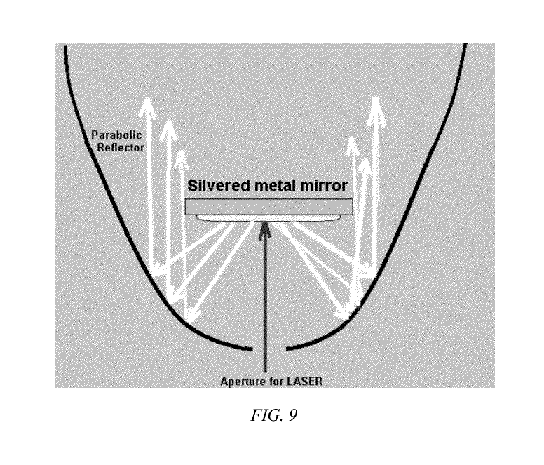

Alternatively, other arrangements to focus the laser beam onto a phosphor containing substrate are possible. A remotely located wavelength conversion phosphor can either be front illuminated or rear illuminated. Most of the converted light is emitted from the same side as that used for illumination so the front illuminated variety is most efficient. Also from a thermal point of view the front illuminated one would allow the phosphor and resin binder to be deposited on a thermally conductive and optically reflective metal substrate, thus assisting in cooling the phosphor/resin mix and reflecting forward light emitted from the rear side of the phosphor. Thus the beam can be arranged to focus into the adaptor as in FIG. 8. For example, the illuminating beam (or beams) are fired past the phosphor and are then reflected back towards it by a mirror, array of mirrors or a diffractive optic designed for the same purpose. Sending the beam past the phosphor introduces an alignment issue of the mirror/mirrors. This configuration causes the output to be at an angle to, or displaced from, the original beam.

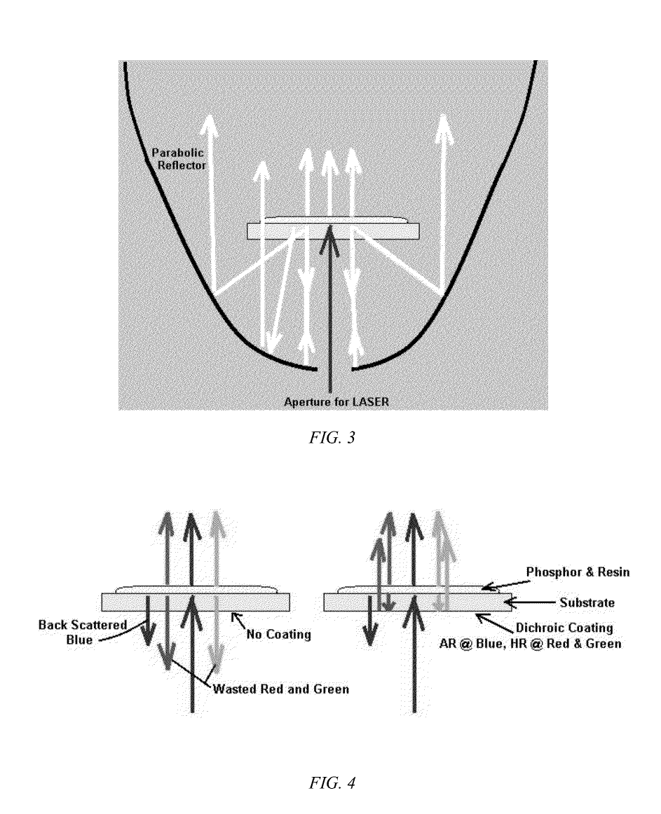

In yet another embodiment, a mirror may be utilized to reflect light onto the reflector as depicted in FIG. 9. Thus using emission from the same side as illumination is achieved by suspending a metal mirror and removing heat from it via heat sinks described herein and attached to the mirror back surface for example. Still further, as shown in FIG. 3, using a transparent substrate and utilizing light emitted from both sides of the phosphor is achieved with heat conducting structures to cool the phosphor mounting transparent substrate. As an example, a sheet forming the heat conducting and mounting functions and filling the entire inside diameter of the reflector is also achieved with the substrate preferably a diamond wafer.

It is appreciated that the present device may include multiple lasers and adaptors, or may split a laser beam into multiple beams for purposes of feeding multiple adaptors.

1. A detachable phosphorescent or fluorescent wavelength conversion device for turning a hand portable laser source into a substantially non coherent light source having different or additional wavelengths to the original laser comprising:
(a) an adaptor housing;
(b) a hand portable laser source, and
(c) a wavelength conversion material further comprising a phosphor adhered to a substrate.

2. The device of claim 1 wherein the substrate is a dichroic mirror.

3. The device of claim 1 further comprising an output focus.

4. The device of claim 1 wherein the device produces a white light source.

5. The device of claim 1 wherein the device produces a colored light source.

6. The device of claim 1 wherein the phosphor is cerium doped YAG phosphor.

7. The device of claim 1 wherein the phosphor is yellow oxynitride phosphor.

8. The device of claim 1 wherein the phosphor is adhered to the substrate by a silicone resin.

9. The device of claim 1 wherein light from the laser source is first passed through a diverging device to reduce the illumination power density on the wavelength conversion material.

10. The device of claim 9 wherein the diverging device is selected from the group consisting of a concave or bi-concave lens, a transmissive diffraction grating and a transmissive holographic element.

11. The device of claim 1 wherein the output focus is a metal reflector.

12. The device of claim 1 wherein the output focus is a total internal reflection refractive optical element.

13. The device of claim 1 wherein the substrate is joined to a heat sink.

14. The device of claim 1 wherein the substrate is transparent.

15. The device of claim 1 wherein the substrate is mirror facing towards the laser source.

16. The device of claim 1 wherein the laser source is coaxial to the adaptor housing.

17. A phosphorescent or fluorescent wavelength conversion device for turning a laser source into a substantially non coherent light source having different or additional wavelengths to the original laser comprising:
(a) an adaptor housing;
(b) an output focus;
(c) a mirror; and
(d) a wavelength conversion material further comprising a phosphor adhered to a substrate.

18. The device of claim 17 wherein the mirror is angled to direct the laser beam onto the wavelength conversion material.

19. A phosphorescent or fluorescent wavelength conversion device for turning a laser source into a substantially non coherent light source having different or additional wavelengths to the original laser comprising:
(a) an adaptor housing;
(b) an output focus and
(c) a wavelength conversion material further comprising a phosphor adhered to a substrate.
